(19) United States
(12) Patent Application Publication
(10) Pub. No.: US 2025/0208473 A1
(43) Pub. Date: Jun. 26, 2025

(54) RAINBOW DIMMABLE FILM AND DIMMABLE GLASS

(71) Applicant: WICUE USA INC., Santa Clara, CA (US)

(72) Inventors: Cai GUO, Santa Clara, CA (US); Fenghua LI, Santa Clara, CA (US)

(73) Assignee: WICUE USA INC., Santa Clara, CA (US)

(21) Appl. No.: 18/395,472

(22) Filed: Dec. 22, 2023

(51) Int. Cl. G02F 1/137; G02F 1/1333; G02F 1/1337; G02F 1/1339

(52) U.S. Cl. CPC G02F 1/13725; G02F 1/133302; G02F 1/1339; G02F 1/1337; G02F 2202/28

(57) ABSTRACT

A rainbow dimmable film includes a first substrate layer, a first conductive layer, a liquid crystal layer, a second conductive layer, and a second substrate layer laminated in sequence. The rainbow dimmable film has a transparent state, a rainbow state, and a dark state, and a level of an operational voltage of the rainbow dimmable film is in a range of 0 V-100V. When an applied voltage of the rainbow dimmable film is 0V or 100V, the rainbow dimmable film is in the transparent state or the dark state; or when the applied voltage of the rainbow dimmable film has a voltage value in a range of 0V to 100V, the rainbow dimmable film is in the rainbow state. When the rainbow dimmable film in the rainbow state is viewed in a direction towards the light source, a rainbow phenomenon occurs.

### TECHNICAL FIELD

The present disclosure relates to the technical field of liquid crystal rainbow dimmable film, and in particular to a rainbow dimmable film and dimmable glass.

### BACKGROUND

With the continuous advancement of science and technology, dimmable film, as a new type of material, is gradually being used in automotive glass, advertising displays, and other fields.

At present, some researchers have achieved the adjustment of various parameters such as light transmittance and reflectivity by introducing adjustable optical structures into the dimmable film; some researchers are using nanotechnology to add the adjustable optical structures to the dimmable film. Nanoparticles with special optical properties are created, allowing for more refined light control. The emergence of these new types of dimmable films provides designers with more choices, allowing them to more flexibly design dimmable film products that meet their needs.

However, existing dimmable films only have one color display and cannot display multiple colors, which to a certain extent reduces the practicality of the dimmable film and the market competitiveness of dimmable film-related products.

### SUMMARY

The main purpose of the present disclosure is to provide a kind of rainbow dimmable film and dimmable glass to improve the practicality and market competitiveness of the product.

In order to achieve the above objects, embodiments of the present disclosure provide a kind of rainbow dimmable film and dimmable glass. The rainbow dimmable film includes a first substrate layer, a first conductive layer, a liquid crystal layer, a second conductive layer, and a second substrate layer that are laminated in sequence. The rainbow dimmable film has three states: a transparent state, a rainbow state, and a dark state. The operational voltage range of the rainbow dimmable film is 0-100V. When the applied voltage of the rainbow dimmable film is 0v or 100V, the rainbow dimmable film is in a transparent state or a dark state. When the applied voltage of the rainbow dimmable film has a voltage value in a range of 0v to 100V, the rainbow dimmable film is in the rainbow state. When the rainbow dimmable film in the rainbow state is viewed in the direction towards the light source, a rainbow phenomenon will occur.

In an embodiment, the liquid crystal material of the liquid crystal layer is a Guest-Host (GH) liquid crystal material.

In an embodiment, the thickness of the rainbow dimmable film is in a range of 50 μm-500 μm.

In an embodiment, the transmittance of the rainbow dimmable film in the dark state is less than or equal to 2%, and the transmittance of the rainbow dimmable film in the transparent state is greater than or equal to 20%.

In an embodiment, the rainbow dimmable film further includes two alignment layers, and the liquid crystal layer is located between the two alignment layers.

In an embodiment, the material of the first substrate layer and the second substrate layer is one of PC, PET, TAC, COC, and COP.

In an embodiment, the adjustment voltage range of the rainbow state of the rainbow dimmable film is 5V-15V.

The second embodiment of the present disclosure also provides a kind of dimmable glass, which includes the above-mentioned rainbow dimmable film.

In an embodiment, the dimmable glass includes a first glass substrate, and the rainbow dimmable film is pasted on the surface of the first glass substrate by using optical adhesive.

In an embodiment, the dimmable glass includes a second glass substrate, a third glass substrate, and a spacer, and the spacer is located at edges of the second glass substrate and the third glass substrate and between the second glass substrate and the third glass substrate, to fixedly connect the second and third glass substrates together. A space is formed between the second glass substrate and the third glass substrate, and a rainbow dimmable film is arranged in this space. The rainbow dimmable film is pasted and fixed on the inner surface of the second glass substrate or the inner surface of the third glass substrate.

Compared with the existing technology, the beneficial effect of the technical solution of the present disclosure is that because the rainbow dimmable film in the embodiment of the present disclosure can not only switch between the transparent state and the dark state, but also switch to the rainbow state, it increases the designer's degree of design freedom. The rainbow dimmable film in the present disclosure is more practical, and the products using the rainbow dimmable film in the embodiment of The present disclosure are also more competitive in the market.

### BRIEF DESCRIPTION OF THE DRAWINGS

FIG. 1 is a schematic cross-sectional view of the rainbow dimmable film in the dark state according to an embodiment of the present disclosure;

FIG. 2 is a schematic cross-sectional view of the rainbow dimmable film in the transparent state according to an embodiment of the present disclosure;

FIG. 3 is a schematic cross-sectional view of the rainbow dimmable film in the rainbow state according to an embodiment of the present disclosure;

FIG. 4 is a schematic structural diagram of one type of the dimmable glasses according to an embodiment of the present disclosure; and

FIG. 5 is a schematic structural diagram of one type of the dimmable glasses according to an embodiment of the present disclosure.

List of reference signs:

| | | |
|---|---|---|
| 100: Rainbow dimmable | 110: first substrate | 120: first conductive |
| film; | layer; | layer; |
| 130: liquid crystal | 131: domain; | 1311: liquid crystal |
| layer; | | molecules; |
| 121: second conductive | 111: second substrate | 140: alignment layer; |
| layer; | layer; | |
| 200: first glass substrate; | 300: second glass | 400: third glass |
| | substrate; | substrate; |
| 500: spacer. | | |

### DETAILED DESCRIPTION

Hereinafter, with reference to the drawings in the embodiments of the present disclosure, a clear and complete description of the schemes in the embodiments of the present disclosure will be provided. It should be apparent that the described embodiments are only a portion of the embodiments of the present disclosure, not all of them. Based on the embodiments of the present disclosure, all other embodiments that those skilled in the art obtain without making inventive contributions fall within the scope of protection of the present disclosure.

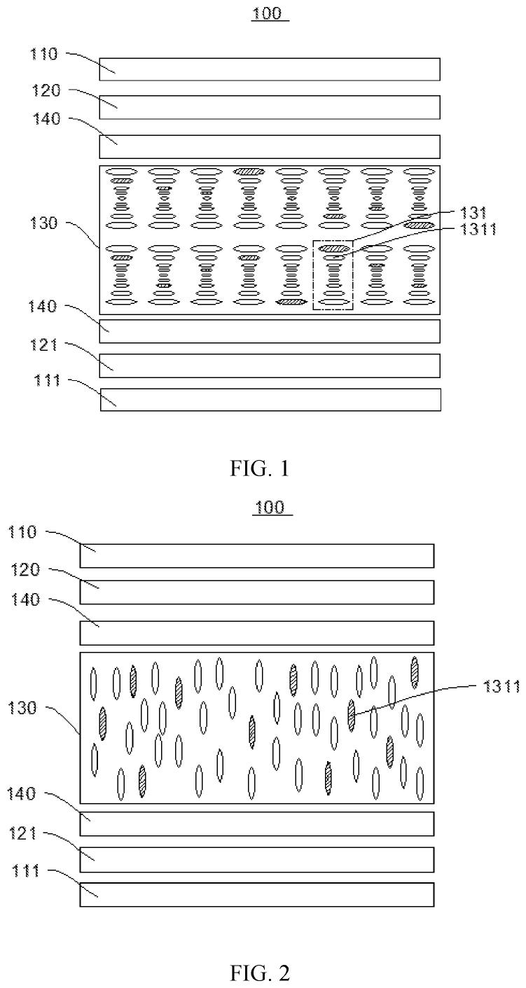

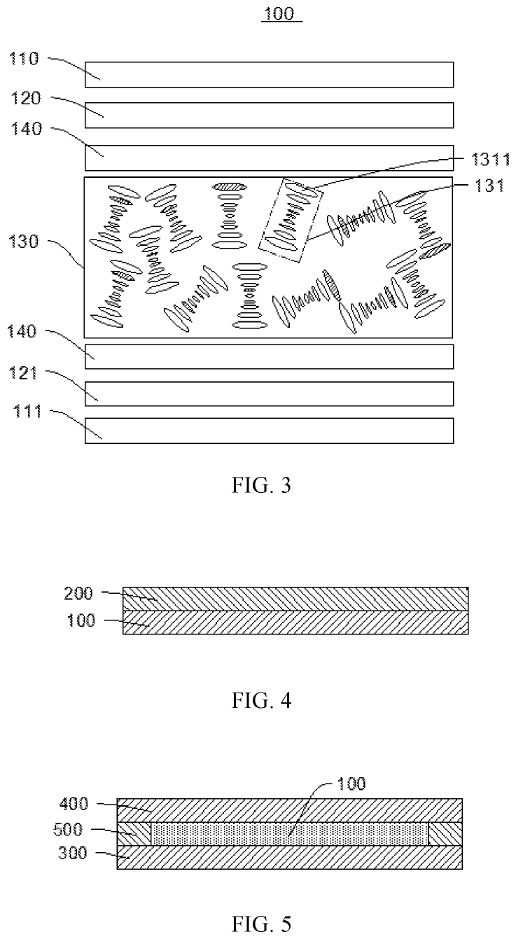

A rainbow dimmable film 100 according to an embodiment of the present disclosure, with reference to FIGS. 1-3, the rainbow dimmable film includes a first substrate layer 110, a first conductive layer 120, a liquid crystal layer 130, a second conductive layer 121, and a second substrate layer 111 that are laminated in sequence. The rainbow dimmable film 100 has three states: a transparent state, a rainbow state, and a dark state. The operational voltage range of the rainbow dimmable film is 0-100V. When the voltage applied to the rainbow dimmable film is 0V or 100V, the rainbow dimmable film is in the transparent state or the dark state. When the applied voltage of the rainbow dimmable film is at a voltage in a range of 0 V to 100V, the rainbow dimmable film is in the rainbow state. When the rainbow dimmable film in the rainbow state is viewed in the direction towards the light source, a rainbow phenomenon will occur.
1. Referring to FIG. 1, dark state: this state is the state of liquid crystal at 0V, that is, no voltage is applied to the liquid crystal. The liquid crystal molecules 1311 in the liquid crystal layer 130 are arranged in a planar spiral around the axis perpendicular to the surface of the first substrate layer 110, and each spiral structure is evenly arranged. At this time, the dye molecules are in a strong light-absorbing state, and the rainbow dimmable film 100 presents a uniform dark state.
2, Referring to FIG. 2, transparent state: this state is a high-voltage driving state. At this time, the liquid crystal molecules 1311 in the liquid crystal layer 130 exhibit a nematic phase structure (co-directional arrangement without spirals). The long axis of the liquid crystal molecules 1311 is parallel to the direction of the electric field and perpendicular to the surface of the first substrate layer 110, the dye molecules (not shown) are in a weak light-absorbing state, and the rainbow dimmable film 100 presents a uniform and transparent state.
3. Referring to FIG. 3, rainbow state: when an intermediate voltage (i.e. any voltage between 0V-100V, excluding 0V and 100V) is applied to the rainbow dimmable film 100, the liquid crystal molecules 1311 in each domain 131 [The angle between the two liquid crystal molecules 1311 that are farthest apart in each domain 131 is 360° (the 360° here refers to the angle formed by a certain liquid crystal molecule 1311 rotating 360° with itself), along the direction perpendicular to the direction of the long axis of the liquid crystal molecule 1311, among the liquid crystal molecules 1311 on opposite sides of the center of the domain 131, the angle between two liquid crystal molecules 1311 that are equidistant from the center of the domain 131 is 360°] are still in a spiral structure, but the spatial orientation of the spiral axis of the liquid crystal in each domain 131 is disordered. The spiral axis of the liquid crystal molecules 1311 in different domains 131 has different directions, forming a focal conic texture. At this time, the discontinuous change of the refraction rate of the liquid crystal molecules 1311 at the boundary of domain 131 will show strong light scattering, and the light scattering will show a bright rainbow phenomenon, especially when viewing a point light source or a strong light source (such as the sun), the rainbow will become more obvious. Furthermore, when we adjust the voltage, the state of the rainbow also changes accordingly. The higher or lower the voltage, the weaker the rainbow will be. The most obvious rainbow effect can be obtained at a certain voltage between 0V-100V.

In an embodiment of the present disclosure, creation and use of traditional light switchable films, traditional light switchable films often only have a transparent state and a dark state to meet the people's daily needs. The rainbow dimmable film 100 in the embodiment can not only switch between the light state and the dark state, but also switch to the rainbow state. The introduction of the rainbow state makes the rainbow dimmable film 100 more beautiful and practical. The product of the rainbow dimmable film 100 according to the embodiment of the present disclosure is also more competitive in the market.

In an embodiment, the liquid crystal material of the liquid crystal layer is a Guest-Host (GH) liquid crystal material.

GH LCD is a highly transparent LCD display with the advantages of no haze and no viewing angle problems. In addition, GH LCD also has stepless dimming, second-level response time, dark-state transmittance as low as less than 1%, and privacy-enhancing features and other features.

In an embodiment, the thickness of the rainbow dimmable film is 50 μm-500 μm.

The thickness of the rainbow dimmable film 100 is in a range of 50 μm and 500 μm, which can better control the transmittance of light, thereby achieving better light adjustment effect. For example, when the thickness of the switchable film is 50 μm, thinner light-transmission layer can be achieved, thereby making the light softer; when the thickness of the dimmable film is 500 μm, a thicker light-transmitting layer can be achieved, thereby making the light more uniform.

In an embodiment, the transmittance of the rainbow dimmable film 100 in the dark state is less than or equal to 2%, and the transmittance of the rainbow dimmable film in the transparent state is greater than or equal to 20%.

In an embodiment, the rainbow dimmable film further includes two alignment layers, and the liquid crystal layer is located between the two alignment layers.

The alignment layer 140 enables the liquid crystal molecules 1311 in the liquid crystal layer 130 to have the required deflection angle (i.e., the angle between the long axis of the liquid crystal molecules 1311 and the alignment layer 140. When the long axis is parallel to the alignment layer 140, it is defined as a deflection angle of 0°) when the rainbow dimmable film 100 is not energized, and is arranged in an orderly manner.

In an embodiment, the material of the first substrate layer 110 and the second substrate layer 111 is one of PC, PET, TAC, COC, and COP.

In an embodiment, the adjustment voltage range of the rainbow state of the rainbow dimmable film is 5V-15V. Within this range, the rainbow state of the rainbow dimmable film 100 is the most obvious, and the display effect of the rainbow state is improved.

A kind of dimmable glass according to an embodiment of the present disclosure is described by referring to FIG. 4 or FIG. 5. The dimmable glass includes the above-mentioned rainbow dimmable film 100.

In an embodiment of the present disclosure, creation and use of traditional light switchable films, traditional light switchable films often only have a transparent state and a dark state to meet the people's daily needs. The rainbow dimmable film 100 in the embodiment can not only switch between the light state and the dark state, but also switch to the rainbow state. The introduction of the rainbow state makes the rainbow dimmable film 100 more beautiful and practical. The product of the rainbow dimmable film 100 according to the embodiment of the present disclosure is also more competitive in the market.

In some embodiments, the dimmable glass can be applied to curtain walls, such as building canopies. When the voltage of the rainbow dimmable film 100 is at 0V or 100V, the dimmable glass is in a transparent state and a dark state respectively. In addition, when the voltage applied on the rainbow dimmable film 100 is at any value between 0 V-100V, the rainbow dimmable film 100 shows a rainbow state. At this time, when the sunlight passes through the dimmable glass on the building canopy, a rainbow appears on the dimmable glass. Compared with the traditional building canopy, which can only display the transparent state and the dark state, the use of the dimmable glass in this embodiment increases the aesthetics of the building canopy and improves people's quality of life.

In some embodiments, the dimmable glass can also be applied to automobile glass. When the voltage of the rainbow dimmable film 100 is at 0V or 100V, the dimmable glass is in a transparent state and a dark state respectively. In addition, when the voltage applied on the rainbow dimmable film 100 is at any value between 0V-100V, the rainbow dimmable film 100 shows a rainbow state. At this time, when sunlight passes through the car glass, the user can see a rainbow in the car. Compared with traditional automotive glass, using the dimmable glass of this embodiment can increase the aesthetics of the automobile glass and improve people's comfort when riding in the car.

A kind of dimmable glass according to an embodiment of the present disclosure is described by referring to FIG. 4. The dimmable glass includes the above-mentioned rainbow dimmable film 100. The dimmable glass includes a first glass substrate 200. The rainbow dimmable film 100 is pasted on the surface of the first glass substrate 200 through optical adhesive.

In an embodiment of The present disclosure, creation and use of traditional light switchable films, traditional light switchable films often only have a transparent state and a dark state to meet the people's daily needs. The rainbow dimmable film 100 in the embodiment can not only switch between the light state and the dark state, but also switch to the rainbow state. The introduction of the rainbow state makes the rainbow dimmable film 100 more beautiful and practical. The product of the rainbow dimmable film 100 according to the embodiment of the present disclosure is also more competitive in the market.

In this embodiment, the dimmable glass is composed of the rainbow dimmable film 100 attached to the first glass substrate 200, which is easy to install and can reduce the production cost of the dimmable glass.

In some embodiments, the dimmable glass can be applied to curtain walls, such as building canopies. When the voltage of the rainbow dimmable film 100 is at 0V or 100V, the dimmable glass is in a transparent state and a dark state respectively. In addition, when the voltage applied on the rainbow dimmable film 100 have a value in a range of 0V-100V, the rainbow dimmable film 100 shows a rainbow state. At this time, when the sunlight passes through the dimmable glass on the building canopy, a rainbow appears on the dimmable glass. Compared with the traditional building canopy, which can only display the transparent state and the dark state, the use of the dimmable glass in this embodiment increases the aesthetics of the building canopy and improves people's quality of life.

In some embodiments, the dimmable glass can also be applied to automobile glass. When the voltage of the rainbow dimmable film 100 is at 0V or 100V, the dimmable glass is in a transparent state and a dark state respectively. In addition, when the voltage applied on the rainbow dimmable film 100 is at any value between 0V-100V, the rainbow dimmable film 100 shows a rainbow state. At this time, when sunlight passes through the car glass, the user can see a rainbow in the car. Compared with traditional automotive glass, using the dimmable glass of this embodiment can increase the aesthetics of the automobile glass and improve people's comfort when riding in the car.

A kind of dimmable glass according to an embodiment of the present disclosure is described by referring to FIG. 5. The dimmable glass includes the above-mentioned rainbow dimmable film 100. The dimmable glass includes a second glass substrate 300, a third glass substrate 400, and a spacer, and the spacer is located on the periphery between the second glass substrate 300 and the third glass substrate 400, which fixedly connected the second and third glass substrates together. A space is formed between the second glass substrate 300 and the third glass substrate 400, and a rainbow dimmable film is arranged in this space (because the rainbow dimmable film 100 has been placed in this space, the space is not shown in FIG. 5). The rainbow dimmable film 100 is pasted and fixed on the inner surface of the second glass substrate 300 or the inner surface of the third glass substrate 400.

In an embodiment of the present disclosure, creation and use of traditional light switchable films, traditional light switchable films often only have a transparent state and a dark state to meet the people's daily needs. The rainbow dimmable film 100 in the embodiment can not only switch between the light state and the dark state, but also switch to the rainbow state. The introduction of the rainbow state makes the rainbow dimmable film 100 more beautiful and practical. The product of the rainbow dimmable film 100 according to the embodiment of the present disclosure is also more competitive in the market.

In this embodiment, since the rainbow dimmable film 100 is located between the second glass substrate 300 and the third glass substrate 400, the second glass substrate 300 and the third glass substrate 400 play a role in protecting the rainbow dimmable film 100, reducing the risk of non-uniform local deformation of the dimmable film 100; it is preferred that the space is sealed to further protect the rainbow dimmable film 100, to prevent moisture in the air from penetrating into the rainbow dimmable film 100 which might lead to haze issues of the rainbow dimmable film 100.

In some embodiments, the dimmable glass can be applied to curtain walls, such as building canopies. When the voltage of the rainbow dimmable film 100 is at 0V or 100V, the dimmable glass is in a transparent state and a dark state respectively. In addition, when the voltage applied on the rainbow dimmable film 100 has a value in a range of 0V-100V, the rainbow dimmable film 100 shows a rainbow state. At this time, when the sunlight passes through the dimmable glass on the building canopy, a rainbow appears on the dimmable glass. Compared with the traditional building canopy, which can only display the transparent state and the dark state, the use of the dimmable glass in this embodiment increases the aesthetics of the building canopy and improves people's quality of life.

In some embodiments, the dimmable glass can also be applied to automobile glass. When the voltage of the rainbow dimmable film 100 is at 0V or 100V, the dimmable glass is in a transparent state and a dark state respectively. In addition, when the voltage applied on the rainbow dimmable film 100 has a value in a range of 0-100V, the rainbow dimmable film 100 shows a rainbow state. At this time, when sunlight passes through the car glass, the user can see a rainbow in the car. Compared with traditional automotive glass, using the dimmable glass of this embodiment can increase the aesthetics of the automobile glass and improve people's comfort when riding in the car.

It should be noted that the technical solutions in the various embodiments of the present disclosure can be combined with each other, but it must be based on the realization by those of ordinary skill in the art. When the combination of technical solutions is contradictory or cannot be realized, it should be considered that such a combination of technical solutions does not exist and is not within the scope of protection claimed by the present disclosure.

What is described above is only part or embodiments of the present disclosure. Neither the text nor the drawings can therefore limit the scope of protection of the present disclosure. All contents of the description and drawings of the present disclosure are used under the overall concept of the present disclosure. Equivalent structural transformations, or direct/indirect application in other related technical fields are included in the scope of protection of the present disclosure.

What is claimed is:

1. A rainbow dimmable film, comprising a first substrate layer, a first conductive layer, a liquid crystal layer, a second conductive layer, and a second substrate layer that are laminated in sequence, wherein the rainbow dimmable film has a transparent state, a rainbow state, and a dark state, and a level of an operational voltage of the rainbow dimmable film is in a range of 0 V-100V, wherein when an applied voltage of the rainbow dimmable film is 0V or 100V, the rainbow dimmable film is in the transparent state or the dark state; or when the applied voltage of the rainbow dimmable film has a voltage value in a range of 0V to 100V, the rainbow dimmable film is in the rainbow state, and wherein when the rainbow dimmable film in the rainbow state is viewed in a direction towards the light source, a rainbow phenomenon occurs.

2. The rainbow dimmable film of claim 1, wherein liquid crystal material of the liquid crystal layer is a Guest-Host (GH) liquid crystal material.

3. The rainbow dimmable film of claim 1, wherein a thickness of the rainbow dimmable film is in a range of 50 μm-500 μm.

4. The rainbow dimmable film of claim 1, wherein transmittance of the rainbow dimmable film in the dark state is less than or equal to 2%, and transmittance of the rainbow dimmable film in the transparent state is greater than or equal to 20%.

5. The rainbow dimmable film of claim 1, further comprising two alignment layers, wherein the liquid crystal layer is located between the two alignment layers.

6. The rainbow dimmable film of claim 1, wherein material of each of the first substrate layer and the second substrate layer is one of PC, PET, TAC, COC, and COP.

7. The rainbow dimmable film of claim 1, wherein an adjustment voltage range of the rainbow state of the rainbow dimmable film is 5 V-15V.

8. A dimmable glass, comprising the rainbow dimmable film, wherein rainbow dimmable film comprises a first substrate layer, a first conductive layer, a liquid crystal layer, a second conductive layer, and a second substrate layer that are laminated in sequence,
wherein the rainbow dimmable film has a transparent state, a rainbow state, and a dark state, a level of an operational voltage of the rainbow dimmable film is in a range of 0 V-100V,
wherein when an applied voltage of the rainbow dimmable film is 0V or 100V, the rainbow dimmable film is in the transparent state or the dark state; or when the applied voltage of the rainbow dimmable film has a voltage value in a range of 0V to 100V, the rainbow dimmable film is in the rainbow state, and
wherein when the rainbow dimmable film in the rainbow state is viewed in a direction towards the light source, a rainbow phenomenon occurs.

9. The dimmable glass of claim 8, comprising a first glass substrate, and the rainbow dimmable film is pasted on a surface of the first glass substrate by using an optical adhesive.

10. The dimmable glass of claim 8, comprising a second glass substrate, a third glass substrate, and a spacer, wherein the spacer is located at edges of the second glass substrate and the third glass substrate and between the second glass substrate and the third glass substrate, to fixedly connect the second and third glass substrates, a space is formed between the second glass substrate and the third glass substrate, and the rainbow dimmable film is arranged in the space, and
wherein the rainbow dimmable film is pasted and fixed on an inner surface of the second glass substrate or an inner surface of the third glass substrate.

11. The rainbow dimmable film of claim 8, wherein liquid crystal material of the liquid crystal layer is a Guest-Host (GH) liquid crystal material.

12. The rainbow dimmable film of claim 8, wherein a thickness of the rainbow dimmable film is in a range of 50 μm-500 μm.

13. The rainbow dimmable film of claim 8, wherein transmittance of the rainbow dimmable film in the dark state is less than or equal to 2%, and transmittance of the rainbow dimmable film in the transparent state is greater than or equal to 20%.

14. The rainbow dimmable film of claim 8, further comprising two alignment layers, wherein the liquid crystal layer is located between the two alignment layers.

15. The rainbow dimmable film of claim 8, wherein material of each of the first substrate layer and the second substrate layer is one of PC, PET, TAC, COC, and COP.

16. The rainbow dimmable film of claim 8, wherein an adjustment voltage range of the rainbow state of the rainbow dimmable film is 5 V-15V.
